(19) United States
(12) Patent Application Publication
(10) Pub. No.: US 2013/0210468 A1
(43) Pub. Date: Aug. 15, 2013

(54) Text Communications Across Wireless Devices Using Private Exchange

(71) Applicants: Kelly Lowther, Lee, NH (US); Jesse Lowther, Lee, NH (US); Christopher Lowther, Lee, NH (US)

(72) Inventors: Kelly Lowther, Lee, NH (US); Jesse Lowther, Lee, NH (US); Christopher Lowther, Lee, NH (US)

(21) Appl. No.: 13/370,306

(22) Filed: Feb. 10, 2012

(51) Int. Cl. H04W 4/06; H04W 88/16

(52) U.S. Cl. 455/466

(57) ABSTRACT

Systems, methods and computer program products for facilitating the communication of business-related (SMS) messages from PBXs to wireless devices are disclosed. In an aspect of the present disclosure, a service provider offers a web, cloud-based service that enables an operator within an organization to have a high volume of two-way communications with an unlimited number of individuals—through SMS texting, instant messaging, pager, web browser, email and voice—all controlled from a single intuitive browser interface tool. Additionally, a complete history of all communications and real time statistics are available to either the operator or an administrator of the organization.

### CROSS REFERENCE TO RELATED APPLICATIONS

This application claims priority to co-pending U.S. Provisional Patent Application No. 61/441,164, filed on Feb. 9, 2011, which is hereby incorporated by reference as to its entire contents.

This Application relates to: U.S. patent application Ser. No. 13/200,240 (Attorney Docket No. 2280.02), titled “Multi-user Text PBX with Multi Message System Capabilities,” filed on Sep. 21, 2011; and U.S. patent application Ser. No. 13/112,352 (Attorney Docket No. 2179.01), titled “Private Branch Exchange for Communicating Messages to and from Wireless Devices,” filed May 20, 2011; each of which is hereby incorporated by reference as to its entire contents.

### BACKGROUND OF THE INVENTION

1. Field of the Invention

The present disclosure generally relates to wireless communications, and more particularly to systems, methods and computer program products for facilitating communications between private branch exchanges and mobile devices.

2. Related Art

In today's technological environment, Short Message Service (SMS) or “text messaging”—any message delivered to a mobile telephone, VoIP telephone, or other type of telephone, mobile device, computer program, or other type of device that contains text-based data and images, sounds, or video—is the most common used data application in the world—more so than email! That is, it has been estimated that as far back as 2008, over 4.1 trillion text messages were sent. And, as far back as 2006, text messaging was an US$80 billion global industry. Currently over 4 billion texts are sent in the United States per day. Some sources state that there are approximately 2.4 billion active users to send messages—of text messaging which represents 74% of all mobile telephone subscribers.

The popularity of SMS is not surprising given the growth of the mobile industry as a whole. In 2010, according to the International Telecommunication Union (ITU), there were 5.3 billion mobile subscribers which represent approximately 77% of the world's population. In contrast, there were only 1.2 billion fixed telephone lines in the world during the same time period. The use of text messaging, however, remains largely personal. Such messages are typically “consumer-to-consumer” and are of a personal nature. That is, an overwhelming majority of text messages sent involve an individual subscriber sending a short (e.g., up to 160 7-bit characters) and personal message to another individual subscriber.

Businesses, on the other hand, who typically employ private branch exchanges (PBXs), have not realized the full power and reach of SMS. PBXs, which often incorporate telephones, fax machines, modems, and the like, make connections among the internal telephones of a private organization—usually a commercial business—and also connect them to the public switched telephone network (PSTN) via trunk lines. As of today, text messaging between businesses and mobile subscribers have mostly involved content delivery and entertainment services (e.g., TV contest voting). Yet, according to the ITU, text messages are read on average within four minutes compared to 48 hours with email, and while 65% of email is spam, less than 10% of SMS is spam. This presents significant new avenues for businesses to communicate with existing and potential customers for increased revenue opportunities.

Given the foregoing, what is needed are systems, methods and computer program products for facilitating the communication of business-related messages from PBXs to wireless devices.

### BRIEF DESCRIPTION OF THE INVENTION

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

The present disclosure meets the above-identified needs by providing systems, methods and computer program products for facilitating the communication of business-related (SMS) messages from PBXs to wireless devices.

In an aspect of the present disclosure, a service provider offers a web, cloud-based service that enables an organization (e.g., a university, a company/business enterprise or local, state or federal government department or agency, a charitable entity or any other type of organization or entity) to have a large number of the organization's personnel (e.g., call center operators, telemarketers, fundraisers, customer service representatives, etc.) handle a large volume of incoming SMS messages from a variety of mobile telephone subscribers capable of receiving such SMS messages. (Such telephone subscribers capable of receiving such SMS messages from the organization may be its actual or potential customers, clients, patients, constituents and/or the like, utilizing a mobile telephone, a desktop computer, a laptop computer, a personal digital assistant (PDA), a tablet or mobile computer, any commercially-available intelligent communications device, or the like, and are collectively referred to herein as “endpoints.”)

In an aspect, the system of the present disclosure allows the flow of the SMS messages to the endpoints to be controlled in real time at the front end by an organizational administrator and divided among the organization's personnel in a variety of ways. In such an aspect, each of the organization's personnel may handle their allocated portion of the SMS message flow to (bi-directionally) communicate with multiple endpoints, and easily manage each conversation in a multi-featured and scalable workspace.

In yet another aspect, the present disclosure allows conversations or dialogues to be given either time values or priority values and presented to the organization's personnel charged with communicating with endpoints accordingly. Individual endpoints can be addressed or multiple endpoints selected and all addressed at the same time. Similarly, workflows or tasks can be easily divided into their own areas and managed accordingly.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram of an exemplary system and method for facilitating the communication of business-related (SMS) messages from PBXs to wireless devices according to an aspect of the present disclosure.

FIG. 2 is a flowchart illustrating operation of the system of FIG. 1, according to an aspect of the present disclosure.

FIGS. 3-4 and FIGS. 6-9 are screenshots illustrating exemplary graphical user interfaces, according to various aspects of the present disclosure.

FIG. 5 is a block diagram of an exemplary computer system useful for implementing the present disclosure.

### DETAILED DESCRIPTION

The present disclosure is directed to systems, methods and computer program products for facilitating the communication of business-related (SMS) messages from PBXs to wireless devices.

In an aspect of the present disclosure, a service provider offers a web, cloud-based service that enables an operator within an organization to have a high volume of two-way communications with an unlimited number of individuals (endpoints)—through SMS texting, instant messaging, pager, web browser, email and voice—all controlled from a single intuitive browser interface tool. Each operator can turn over their workspace intact to another operator (i.e., during a shift change) so that work can continue. Additionally, a complete history of all communications and real time statistics are available to either the operator or an administrator.

In such an aspect of the present disclosure, the web cloud-based service may be utilized by any organization that schedules appointments and sends reminders to clients or patients, such as a medical practice, dental practice, chiropractic practice, barber shop, hair salon, spa, hotel, appliance repair service, library, delivery service, car rental service, auto body shop, car repair center, veterinary clinic and the like. Such organizations would use the SMS messaging application provided by the present disclosure to send reminders to patients or clients about pending appointments, as well as receive confirmations from such patients or clients that they will keep their previously-scheduled appointments. These organizations may also use the texting application to allow patients or clients to schedule appointments within available time slots without requiring a customer service representative from the organization to communicate “live” with the patients or clients.

In another aspect of the present disclosure, the web, cloud-based service may be utilized by any organization that seeks to communicate with customers—individuals, persons, businesses—via SMS, such as software development firms, consulting service firms and the like, to provide technical support or customer service by holding text conversations with such customers as they seek information, service or support.

In another aspect of the present disclosure, the web, cloud-based service may be utilized by any organization that seeks to maintain contact with a group of vehicles or individuals in the field (i.e., fleet management) such as delivery services, police and fire departments, emergency vehicle services, repair services, fuel delivery services and any other operation that would benefit from being able to maintain contact with field personnel.

The present disclosure is now described in more detail herein in terms of the above exemplary business services context. This is for convenience only and is not intended to limit the application of the present disclosure. In fact, after reading the following description, it will be apparent to those skilled in the relevant art(s) how to implement the following disclosure in alternative aspects.

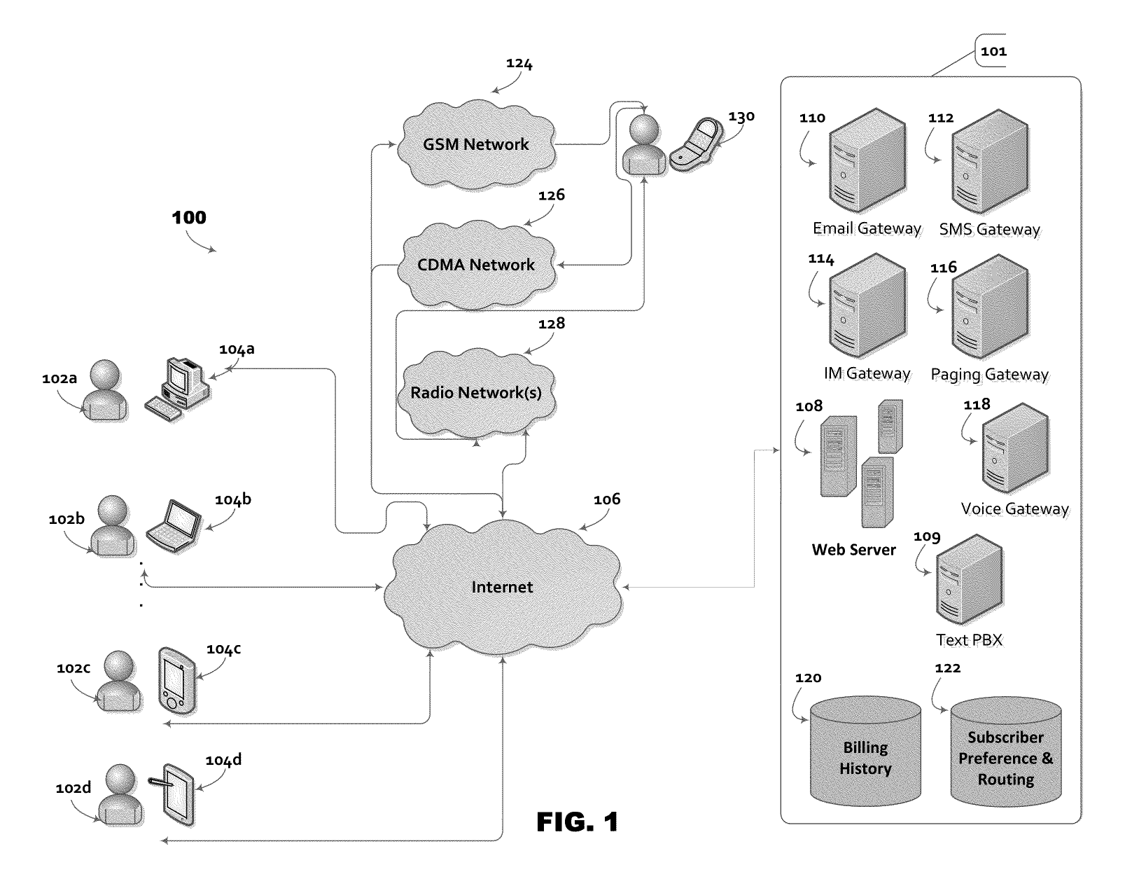

Referring to FIG. 1, a block diagram illustrating an exemplary cloud-based, PBX-to-wireless devices communication system 100, according to an aspect of the present disclosure, is shown. Cloud-based, PBX-to-wireless devices communication system 100 includes a plurality of an organization's personnel users (e.g., call center operators, telemarketers, fundraisers, customer service representatives, etc.) 102 (shown as users 102a-d in FIG. 1) accessing—via a computing device 104 (shown as respective computing devices 104a-d in FIG. 1) and a network 106, such as the global, public Internet—an application service provider's cloud-based, PBX-to-wireless device (hardware and software) infrastructure 101. In various aspects, computing device 104 may be configured as a desktop computer 104a, a laptop computer 104b, a personal digital assistant (PDA) 104c, a tablet or mobile computer 104d, any commercially-available intelligent communications device, or the like.

As shown in FIG. 1, in an aspect of the present disclosure, an application service provider's cloud-based, PBX-to-wireless communications infrastructure 101 may include a web server 108, an email gateway 110, an SMS gateway 112, an instant message (IM) gateway 114, a paging gateway 116, a voice gateway 118, a billing history database 120 and a subscriber preference and routing database 122. In such an aspect, cloud-based, PBX-to-wireless communications infrastructure 101 would be connected to one or more telecommunications networks such as a GSM network 124, a CDMA network 126, a radio network 128 or the like. Such networks 124-128 would allow cloud-based, PBX-to-wireless communications infrastructure 101 to communicate with one or more endpoints 130 via SMS, voice, email and/or paging utilizing the appropriate one of gateways 110-118.

As will be appreciated by those skilled in the relevant art(s) after reading the description herein, in such an aspect, a service provider—an individual, person, business, or automated system who may be providing a good or service—may allow access, on a free registration, paid subscriber and/or pay-per-use basis, to infrastructure 101 via one or more World-Wide Web (WWW) sites on Internet 106. Thus, system 100 is scaleable such that multiple organizations' personnel 102 may utilize it to facilitate the communication of business-related (SMS) messages from PBXs to wireless devices.

As will also be appreciated by those skilled in the relevant art(s), in an aspect, various (login, admin, account, information, resource, logout, payment, registration, communications, etc.) screens would be generated by server 108 in response to input from users 102 over Internet 106. That is, in such an aspect, server 108 is a typical Web server running a server application at a Web site which sends out Web pages in response to Hypertext Transfer Protocol (HTTP) or Hypertext Transfer Protocol Secured (HTTPS) requests from remote browsers on various devices 104 being used by various users 102. Thus, server 108 is able to provide a graphical user interface (GUI) to users 102 of system 100 in the form of Web pages. These Web pages sent to the user's PC, laptop, mobile device, PDA or the like device 104, and would result in the GUI being displayed.

As will also be appreciated by those skilled in the relevant art(s) after reading the description herein, alternate aspects of the present disclosure may include providing the tool for facilitating the communication of business-related (SMS) messages from PBXs to wireless devices as a stand-alone system (e.g., installed on one PC) or as an enterprise system wherein all the components of infrastructure 101 are connected and communicate via an inter-corporate wide area network (WAN) or local area network (LAN), rather than as a Web service (i.e., application service provider (ASP) model) as shown in FIG. 1.

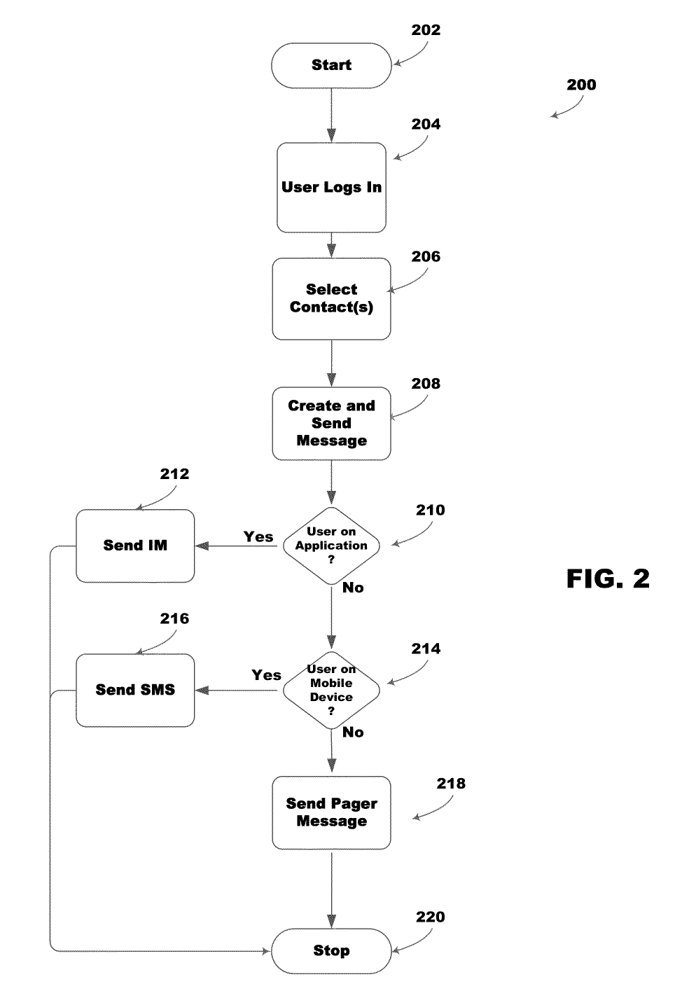

Referring to FIG. 2, a flow diagram 200 describing the sending of a dialogue operation of system 100, according to an aspect of the present disclosure, is shown. Process 200 begins at step 202 and proceeds immediately to step 204.

In step 204, a user 102 utilizes a device 104 to log into the cloud-based application provided by PBX-to-wireless communications infrastructure 101. Such login process would involve user 102 accessing a GUI produced by server 108 and supplying a previously-issued (i.e., during an organization/user registration process) login and password. Then, in step 206, the user selects one or more contacts to which they desire to send a message. Such contact may be previously stored in database 122 or supplied “on the fly” during process 200.

In step 208, user 102 creates a message to be sent to the one or more contacts selected in step 206 and, upon finishing creating the message, indicates to the GUI they desire to actually send the message. Then, in step 210, it is determined whether the contact is also directly logged into the application provided by PBX-to-wireless communications infrastructure 101. If so, process 200 proceeds, in step 212, to send the created message to the contact 130 in the form of an IM via gateway 114.

If the determination of step 210 is negative, process 200 proceeds to step 214 where it is determined whether the contact is utilizing a mobile telephone (as endpoint 130). If so, the message is sent to the contact in the form of an SMS via gateway 112. The mobile (wireless) network operator (i.e., either network 124, 126 or 128) would then locate the mobile telephone of the contact. When the mobile device is located, the SMS is then sent to it. The network operator then sends a “Message Sent” message back to infrastructure 101, which reports it to user 102.

If the determination of step 214 is negative, process 200 proceeds to step 218 where the message is sent to the contact in the form of a pager message (i.e., by default) via gateway 116. The mobile network operator (i.e., either network 124, 126 or 128) would then locate the pager device (as endpoint 130) of the contact. When the pager device is located, the message is then sent to it. The network operator then sends a “Message Sent” message back to infrastructure 101, which reports it to user 102.

Process 200 then terminates as indicated by step 220. In an aspect of the present disclosure, each step of process 200 is logged and stored in to billing history database 120. Further, in an aspect of the present disclosure, any reply message sent by the contact (i.e., endpoint 130) to user 102 would follow the same process as described above. That is, any reply message is routed back to user 102 from endpoint 130, via network 124, 126 or 128 and the appropriate gateway 110-118. In such an aspect, when the reply message is successfully delivered to user 102, the applicable network operator sends a “Message Sent” message back to infrastructure 101, which reports it to endpoint 130.

As mentioned above, as will also be appreciated by those skilled in the relevant art(s) after reading the description herein, in an aspect, various GUI screens would be generated by server 108 in response to input from users 102 and endpoints 130 on their respective devices 104 over the Internet 106. In an aspect, such GUI would include screens to allow users 102 and endpoints 130 to: (1) Create a new dialogue; (2) Create a new contact; (3) Edit existing contacts; (4) Import a list of contacts from a file (e.g., a file previously stored on device 104 and uploaded to be stored in database 122 for later use in specifying one or more recipients of a future dialogue); (5) Create a new “roster” (i.e., a distribution list or subgroup) of contacts; (6) Edit existing rosters; (7) Send an immediate broadcast message; (8) Send a scheduled broadcast message at a user-selected future time and date; (9) Seek online help; (10) Select a screen layout to change the number of conversation boxes that appear in the active screen area; (11) Change their online status so as to be visible to the user's contact/roster list; (12) Edit their profile; (13) Edit their preferences; (14) Edit and view their billing information; and (15) Log out of the application.

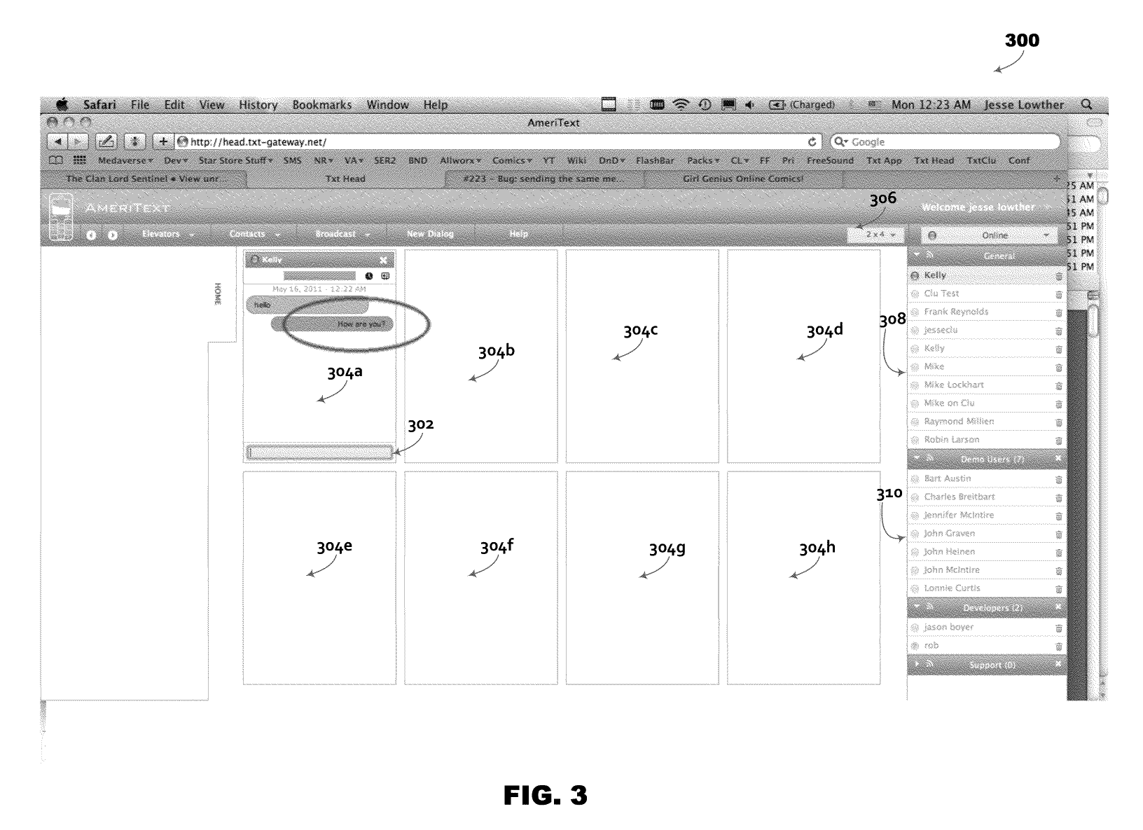

Referring to FIG. 3, an exemplary dialogue graphical user interface screen 300, as may be provided to user 102 (e.g., during message creation step 208 of process 200) in an aspect of the present disclosure, is shown. Dialogue graphical user interface screen 300 includes a text input area 302 for user 102 to input (i.e., type or paste) text to create an SMS, IM, email or pager message to an endpoint 130. Dialogue graphical user interface screen 300 also includes one or more conversation areas 304 (shown as areas 304a-h in FIG. 3) where user 102 can view previous messages sent to, and received from, endpoints 130. In an aspect, area 304 may be color coded to easily distinguish sent and received messages. Dialogue graphical user interface screen 300 also includes a layout selection drop down menu 306 such that a user 102 can select how many conversation areas 304 (and their geometric layout) simultaneously appear on their device 104 while using the application provided by infrastructure 101. Dialogue graphical user interface screen 300 also includes a contact list display area 308 and one or more roster display areas 310.

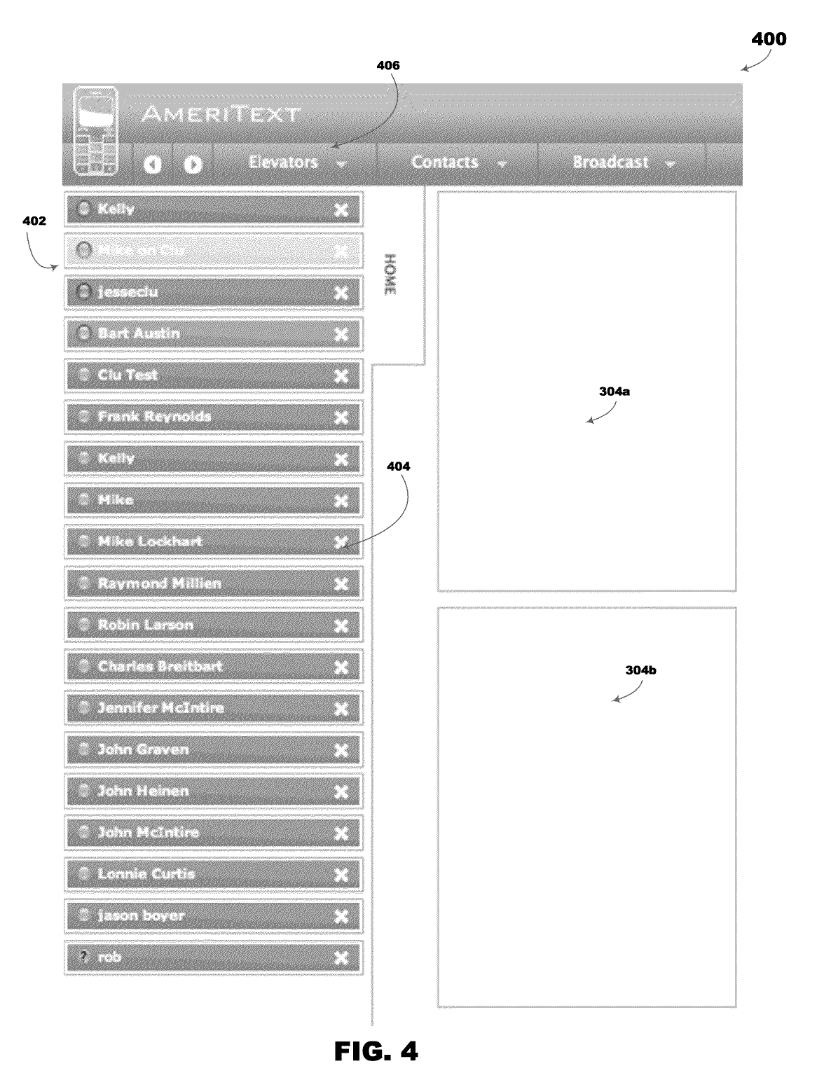

In an alternate aspect of the present disclosure, GUI screens would be generated by the application provided by infrastructure 101 to supply users 102 with an “elevator” user interface to manage simultaneous dialogues (i.e., conversations) with multiple (i.e., hundreds) of endpoints 130. Such elevator user interface is explained below while making reference to FIG. 4, which is an exemplary elevator user interface screen 400 that may be provided to user 102 in aspects of the present disclosure.

In an aspect, elevator user interface 400 consists of a long column (elevator) 402 designed to list endpoints 130 from which user 102 may select and hold conversations with at any time. In an aspect, long column of contacts 402 of interface 400 is ordered in descending order based upon the amount of time that has elapsed since endpoint 130 last communicated with user 102 or by some other criteria selected by user 102. This feature gives user 102 a clear indication of which endpoints 130 have waited the longest to communicate with user 102 or are the most important to the organization. This effectively makes the elevator a queue for endpoints 130 who are waiting to communicate with user 102.

In such an aspect, user 102 can quickly and easily send endpoints 130 to elevator 402 by double-clicking an endpoint 130 from, for example, within contact list display area 308. User 102 may also easily retrieve endpoints from elevator 402 for placement in one of many active conversation areas 304 (shown as areas 304a-b in FIG. 4) by double-clicking on an endpoint 130 in elevator 402. User 102 can further decide where to place an endpoint 130 within elevator 402 by clicking on an endpoint 130 and dragging the endpoint 130 to a location in the active conversation area 304 area where user 102 wishes to have a conversation with endpoint 130. For further convenience, elevator user interface 400 may have a button that will add as many endpoints to the active area 304 as it can hold (based on, for example, the layout selected using layout selection drop down menu 306) and another button that will send all endpoints 130 in active area 304 back to elevator 402.

In an alternate aspect of the present disclosure, infrastructure 101 supplies users 102 with a multiple elevator user interface. In such an aspect, multiple elevators 402 give user 102 an ability to arrange their work flow. When a user 102 selects a different elevator 402, the dialog boxes 304 change in the active area to match those in the selected elevator 402.

In an aspect, endpoints 130 in an elevator are color-coded to reflect their current status and priority (as customized by a user 102 or the organization's administrator). For example, green status may mean an endpoint 130 was the most recent to send a message in the conversation and has been waiting from 1-30 seconds for user 102 to reply. Yellow status, for example, may mean endpoint 130 was the most recent to send a message in the conversation and has been waiting from 31-60 seconds for user 102 to reply. Red status, for example, may mean endpoint 130 was the most recent to send a message in the conversation and has been waiting longer than 60 seconds for user 102 to reply. Blue status, for example, may mean user 102 was the most recent to send a message in the conversation and has been waiting for endpoint 130 to reply for less than five minutes. Gray status, for example, may mean user 102 was the most recent to send a message in the conversation and has been waiting for endpoint 130 to reply for longer than five minutes and the conversation with endpoint 130 may be considered as being concluded.

In an aspect, elevator user interface 400 will order endpoints 130 in elevator 402 based upon status in the following order from top to bottom: red, yellow, green, blue, and gray. This gives user 102 a clear understanding of which endpoints 130 have been waiting the longest to communicate with user 102, as well as which endpoints are not likely to respond any further.

As endpoints 130 wait in elevator (queue) 402, their priority color will change as more time elapses until user 102 sends an endpoint 130 a message and the endpoint's color status changes accordingly. This is done to reflect that user 102 does not need to immediately communicate to that specific endpoint 130 as user 102 had the last word in the conversation and is awaiting a reply from the endpoint 130. In an aspect, each endpoint 130 has an “X” box 404 which user 102 can click on to close the conversation with the endpoint, removing it from elevator 402. In an aspect, elevator user interface 400 includes a drop down menu 406 such that multiple elevator 402 tabs are offered to user 102 for storing multiple elevators (queues) 402. User 102 can create and rename tabs in order to maintain separate lists of endpoints. In an aspect, a new tab with a new elevator 402 is also created when user 102 sends a broadcast message. The new elevator 402 will contain all of the recipients of the broadcast message to better enable management of the broadcast.

In another aspect of the present disclosure, a customer entity may call a telephone number, after which either such customer will hear either an automated message system or a live representative asking if such customer would like to receive a text message. In such aspect, the customer entity may have the option to confirm that they would like to receive a text message and the option to enter a telephone number that such customer entity wishes to have text messages sent to. (i.e., by audio cue, button press, voice command or the like).

In another aspect of the present disclosure, a customer entity may reserve a flight via text message and receive a text message notification from the airline, travel site, or provider entity with whom the flight was reserved. Such text message will contain information regarding the flight (e.g., check in time, time of flight, flight length, seating itinerary, ticket cost, potential upgrade cost, callback number, and other pertinent information regarding flight and preparations prior to flight).

In yet another aspect of the present disclosure, a customer who has reserved a flight may receive a text notification from the airline, travel site, or other provider entity with whom the flight was reserved. Such text message may contain flight reminders (e.g., check in time, time of flight, flight length, seating itinerary, ticket cost, potential upgrade cost, callback number, and other pertinent information regarding flight and preparations prior to flight). Customer entity may receive such text message at some designated time prior to the flight.

In another aspect, the present disclosure may allow a customer entity to reserve a car from a rental company (or other provider entity) via text message. Customer entity may receive a text message notification from the reservation entity containing information regarding the car (e.g., when car will be ready, make and model of car, location of car, gas remaining in car, callback number for provider entity, and other pertinent information regarding car and preparations that must be taken prior to renting such car) among other information.

In an aspect of the present disclosure, a customer entity reserving a car may receive a text message notification from the rental company, travel site, or other provider entity with whom the car was reserved. Such text message will contain information regarding the car (e.g., when car will be ready, make and model of car, location of car, gas remaining in car, callback number for provider entity, and other pertinent information regarding car and preparations that must be taken prior to renting such car) among other information.

In yet another aspect of the present disclosure, a customer entity may send a text message to a doctor's office or other provider entity to schedule an appointment. Such customer entity may have the option to request an appointment via text messaging. The provider entity may then reply via text message with a list of available times for such appointment. Customer entity may then select a time for such appointment from provider entity via text message. At which point the provider entity may confirm such appointment with customer entity using text messaging.

In another aspect, a customer entity who has scheduled an appointment from a provider may receive a text message notification from the provider from whom the appointment was made. Such text message may contain information regarding the appointment (e.g., time of appointment, address for appointment, doctor's name, special appointment requirements, callback number, and preparations to take prior to the appointment) among other information.

In another aspect of the present disclosure, a customer entity may have the option to send a text message to a hair salon, spa, or other provider entity to schedule an appointment. The hair salon, spa, or other provider entity may then reply with a list of available times for such appointment, at which point the customer entity may then select a time for an appointment (all via text messaging). Provider entity may then confirm the appointment with such customer via text message and the customer entity may have the option to confirm the cost of the appointment among other pertinent information prior to such appointment via text messaging.

In an aspect of the present disclosure, a customer entity who has scheduled an appointment may receive a text message notification from the hair salon, spa, or other provider entity with whom the appointment was made. Such text message will contain information regarding the appointment (e.g. time of appointment, address for appointment, stylist or representative name, special requirements for the appointment, callback number, preparations to take prior to appointment, and accepted payment methods) among other information.

In an aspect of the present disclosure, a customer entity may have the option to send a text message to a veterinary clinic or other provider entity to schedule an appointment. Customer may request an appointment, and the veterinary clinic or other provider entity may reply with a list of available times for such appointment. Customer may then select an appointment time (all done via text messaging). Customer may then confirm cost of appointment among other information prior to appointment via text message.

In an aspect, a customer entity who has scheduled an appointment may receive a text message notification from the veterinary clinic or other provider entity with whom such appointment was made. Such text message may contain information regarding the appointment (e.g. time of appointment, address for appointment, veterinarian or representative name, special requirements for the appointment, callback number, preparations to take prior to appointment, and accepted payment methods) among other information.

In yet another aspect of the present disclosure, a customer entity may receive a text message regarding a particular good or service which was recently received (i.e. repair, delivery, installation, or other form of good or service) from a provider entity. Customer may provide ratings and/or feedback regarding such performance of the good or service from provider entity.

In another aspect of the present disclosure, a customer entity seeking employment through an employment agency or other provider entity may receive text messages regarding available jobs. Customer entity may reply to such text message to inform provider entity of desire to apply for potential job. The provider entity may send a text message to customer entity regarding when interviews for potential jobs may be available. The customer entity may then have the option to select an interview time at which point the provider entity may reply to the customer entity confirming pertinent information related to such interview (e.g., interview time, address of interview, and apparel requirements) among other information.

In an aspect, a customer entity may receive text messages from a dating service, match making service, or other provider entity informing them of potential romantic matches from such provider entity. Customer may then reply via text messaging and inform provider entity whether they are interested in such potential match. Should customer entity be interested, provider entity may then act as a proxy between customer entity and potential match such that the customer entity and potential match may not see one another's telephone numbers (or other identifying information) while customer entity and potential match exchange text messages.

In another aspect, a customer entity may reserve lodging—any hotel, motel, or other location where a customer entity may rent a room or other location for any purpose—via text messaging. A customer may specify pertinent desired information (i.e. size of the room, number of guests, start/end date of reservation, and special circumstances surrounding room) among other information. Customer entity reserving lodging reservation may receive a text message notification from lodging company, travel site, or provider entity with whom such lodging reservations were reserved. Such text message may contain information regarding the lodging information (e.g. when reservation will be ready, room or suite number, type of room/suite reserved, address of lodging, cost of room, and payment methods) among other information. Customer entity may then confirm cost of lodging prior to lodging via text messaging.

In an aspect of the present disclosure, a customer may receive text messages as a reminder of books or other borrowed items from a library or other provider entity. Such text messages may remind the customer entity of when the books or other borrowed items are due back to the library or provider entity. Such customer additionally may have the option to perform a library search via text message (i.e. determine if a library carries a book, video, or other item customer entity is seeking), or may have the option to reserve a book, video, or other item from a library or other provider entity such that customer entity may pick up such item at specified later time.

In yet another aspect, a customer entity that has a vehicle, watercraft, computer, appliance, or other item in need of service, that has scheduled an appointment for such servicing with a provider entity, may receive a text message reminding them of such service appointment. Text message may contain information regarding such appointment (e.g. time of appointment, address for appointment, service person or representative name, special requirements for the appointment, callback number, preparations to take prior to appointment, and accepted payment methods) among other information. A customer may then determine through text messaging availability, time, and price (among other pertinent information) of such service appointment, and may schedule such appointment.

In an aspect of the present disclosure, a customer entity may receive a text message to remind them of the expiration of a driver's license, passport, non-driver photo identification, or other form of license or identification that is in need of renewing. Such text message may contain information regarding renewal (e.g., time of appointment, address for appointment, service person or representative who will assist's name, special requirements for the appointment, callback number, preparations to take prior to appointment, and accepted payment methods) among other information.

In another aspect, a customer entity may receive a text message from an insurance provider, magazine provider, newspaper provider, or other provider entity providing a service which requires regular renewing for continued service. Such text message may remind customer entity that a service the customer entity is receiving may expire and is in need of renewal. Such text message may contain information regarding renewal (e.g., name of agent or representative assisting in renewing service, special requirements for renewing, callback number, special preparations necessary prior to the renewal, and payment methods accepted by provider entity) among other information. Provider entity may send a text message to a customer entity reminding them that customer entity may be billed for a service again shortly and that customer may be charged for such automatic renewal of service.

In an aspect of the present disclosure, a customer entity may have the option to order fuel, including heating oil or gas, to be delivered to a place of residence or business via text messaging after having previously set up an account with such fuel provider. The customer entity may then specify the address, time of delivery, amount of fuel to purchase, type of fuel to be purchased, and payment method. Provider entity may then send a text message to customer entity confirming such information among other information. Provider entity may then send text messages to the customer entity at a designated time before fuel delivery is to be made.

In yet another aspect, a customer entity may schedule an installation or maintenance appointment via text messaging and may receive a text message from a cable provider, service person, or other provider entity to remind customer entity of scheduled appointment for home installation of new piece of furniture, appliance, or service (e.g., satellite, cable, heating or ventilation systems, electrical work, or another service potentially installed or maintained in a home). Such text message may contain information regarding installation or maintenance (e.g., type of installation or service being performed, name of service person or representative assisting, special requirements, call back number, and payment methods accepted by the provider entity) among other information.

In an aspect of the present disclosure, a customer entity may receive a text message from a debt collection agency or other provider entity reminding them of a debt they have not yet paid. Such text message may contain pertinent information (e.g. amount of debt, name of company or provider entity looking to collect the debt, name of company or provider entity owed the debt, time by which provider entity expects customer entity to pay the debt, and payment methods accepted by provider entity that may be used to pay the debt) among other information.

In another aspect, a customer entity may receive a text message informing them of a telephone conference that will be taken place at a designated period of time. Such text message may include pertinent information about the conference call (e.g. time of conference call, topic of conference call, list of individuals who may be participating in call, login and/or password for accessing conference call, and telephone number to connect with conference call) among other information. Customer entity may receive a text message at exact time of conference call prompting customer entity to call included telephone number to immediately connect customer to conference call. The Customer entities may also text or return the text and cause the conference system or Conference Bridge to call customer entity directly. The customer entity may also return the call of Long Code DID to start the conference call. Customer entity, using the Internet web interface, may also select a number of users by various methods and then initiate a conference call with all selected users.

In another aspect of the present disclosure, a group of customer entities may receive a text message regarding a planned meeting; such text message may ask each customer entity to choose from a list of times and select one that is the best for the meeting. After all customer entities have replied, the texting application may automatically choose the time that works best for the highest number of customer entities and send out another text message to all customer entities containing the time of the meeting. Customer entities can then reply to such text message with whether they will attend the meeting.

In another aspect, a customer entity that is a member of a sales force, team of engineers, team of chefs, group of individuals participating in a medical study or psychological study, or any form of experiment or any other group of individuals working towards common goals on a workforce may receive text messages as a means of delivering information to the members of the group. Such text messages may contain pertinent information about the activities of the group (i.e., upcoming events that all group members should be a part of, schedule changes, additions or deletions from the group, new potential activities for the group, new potential activities for the group, information that the group supervisor would like to obtain from the group, questions group supervisor would like group to answer) among other information the group should be made aware of.

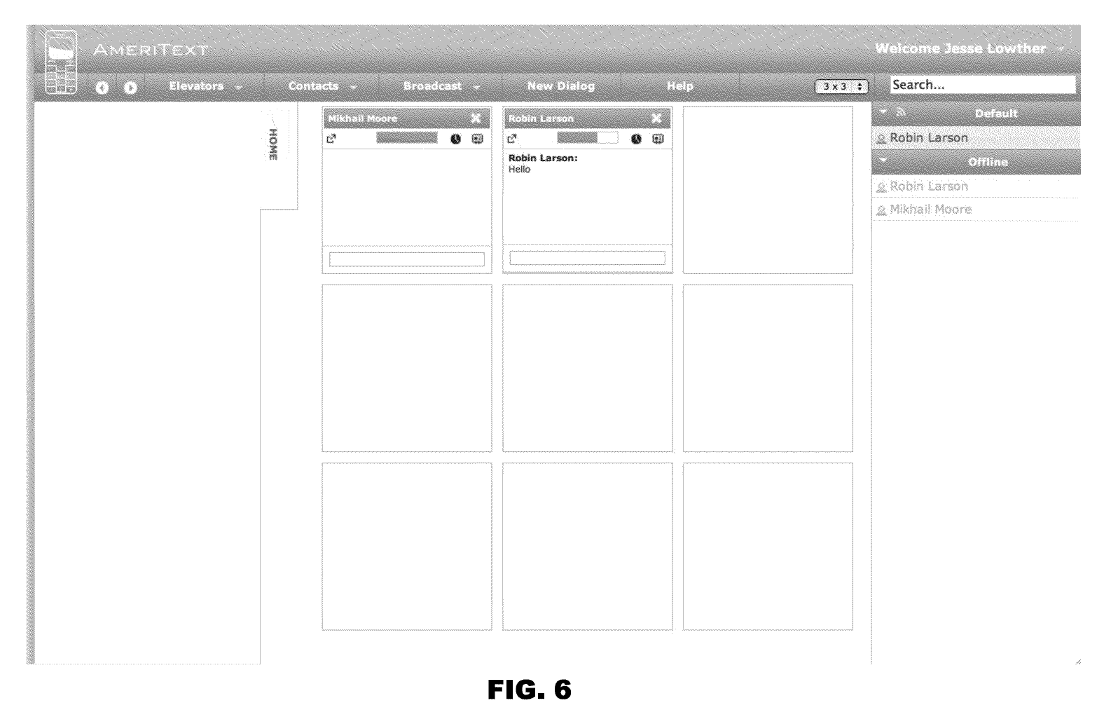

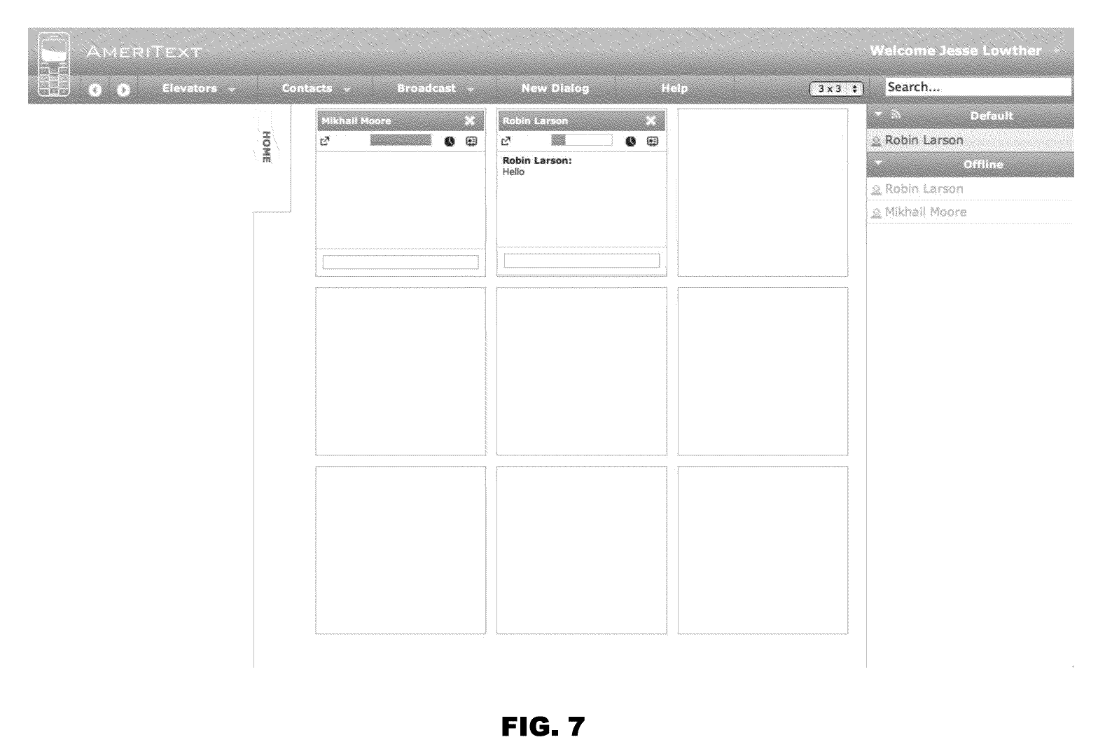

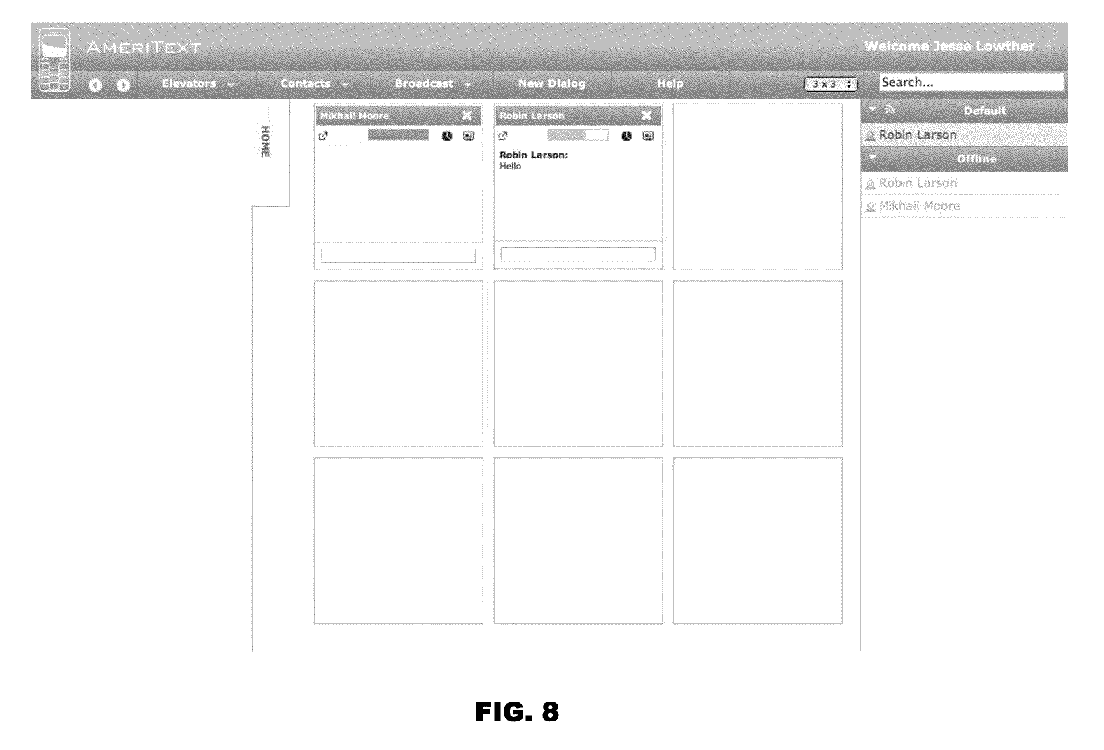

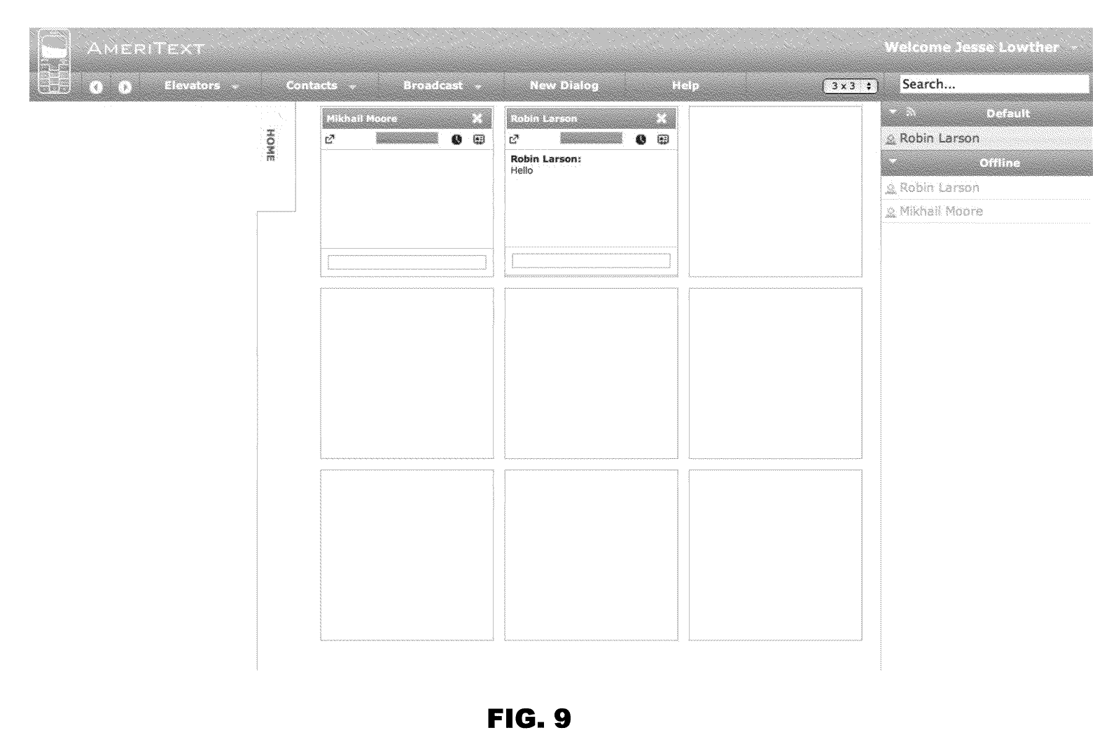

In another aspect of the present disclosure, a user entity using a text message sending application may have indicators that indicate how long a message from an endpoint has gone unanswered. Such indicator may be visual and may give the user entity a clear indication of how much time has elapsed since the endpoint last sent a message to the user entity. Such indicator may appear as a bar (either horizontal, vertical, or diagonal) that may diminish (from left to right, right to left, top to bottom, bottom to top, center to ends, or ends to center). The bar may have multiple stages to communication different intervals of time that have passed since user entity last responded to an endpoint. The bar may change color, flash, or use another means to indicate how much time has passed. The bar may also start filled with a specific color (depending upon the stage) and the color may diminish to reveal another color behind it (see FIGS. 6-9). The indicator may also appear as a circle, square, rectangle, or other shape that may change colors, appearance, flash, or in some other way alert the user that time is passing and the user has not responded to the endpoint. The indicator may also be a timer or other numerical display that may indicate how much time has elapsed since the user last responded to the endpoint. The timer may be in seconds, minutes, or any other indicator that will demonstrate both the stages of elapsed time and the exact amount of elapsed time.

In another aspect of the present disclosure, a customer entity may receive text messages from a service that will alert the customer of pertinent information. The customer may receive such texts notifying such customer about any number of events (i.e., customer needs to move their car, there is an upcoming event customer plans to attend, customer has been out bid in an auction, and any other situation where a customer entity will be notified of an event or happening that is of significance) among other information. Customer entity may be prompted to reply to this message with input regarding the event (i.e., whether they will attend the event and whether they wish to perform a certain action regarding the event or happening) among other information.

In another aspect, a user entity may see the location of a customer entity by the text messages sent by the customer. Each text message may carry the geographical location of the customer. This information may be viewed by the user entity and used for other purposes.

In an aspect of the present disclosure, a user entity using a text message application may generate a report file that may contain pertinent information about the user entity's history of using the texting application (i.e., total number of messages received, total number of messages sent messages sent, statistics such as the average time between the first message received in a conversation from a customer entity and the last message received from the customer entity in the same conversation, statistics such as the average number of simultaneous active conversations the user entity has held during specific time frames, statistics such as the average time it takes the user entity to reply to a text message, a list of flagged words or terms and where they can be found in the conversation history, a history of the total number of conversations held over the course of the user entity's usage of the texting application, the number of trouble tickets closed by the user entity, and the average time trouble tickets opened by the user entity remained open and the total number of trouble tickets opened by the user entity and the total number of trouble tickets closed by the user entity) among other information. The report file may also contain a list of all conversations had by the user entity, and may be ordered by date, incoming telephone number from the endpoint, or other criteria (including search criteria).

In another aspect, a user entity may see a statistic in the text message application indicating how many messages such user entity has sent and how many messages are awaiting replies. Messages that are awaiting replies may be messages at which the endpoint was the last one to speak in the conversation.

In an aspect, a user entity may be able to forward messages from endpoints to other endpoints (be they SMS, instant messenger, pager or another form of text message client or service). Forwarding may be accomplished through any number of means, including but not limited to selecting text to forward, copying the text and pasting it and any other means of transferring text from a user entity to an endpoint.

In another aspect, a text messaging application may be capable of determining whether incoming text messages need to be routed to a user entity or given an automatic response to the incoming text message. Such text messaging application may evaluate the content of the incoming text message based upon a number of factors, and in doing so generate the criteria to determine where the text message should be routed.

In an aspect of the present disclosure, a text messaging application may determine the best service (i.e. SMS gateways, instant message networks, and any other service capable of sending messages in the form of text) to send a text message. Such texting application may determine the best choice for service based upon a number of factors, including but not limited to the source service of the last incoming message from an endpoint, the amount of time that has elapsed since the endpoint last communicated with a user entity, and the known schedule of the endpoint which may determine which service the endpoint should receive the next text message on.

In another aspect of the present disclosure, a text messaging application may determine the emotional content of a message. The emotional content may be the overall tone of the message, including whether or not the message is happy, hostile, upset, or indicates any other type of emotional response. Such information may then be communicated to third parties. The content reading system may also detect and eliminate flagged words that may appear in a message, eliminating the use of profanity in the text message.

In yet another aspect, the customer entity may send a text message to a provider entity, requesting pricing information on goods or services among other information. The provider may also reply with pricing and any other pertinent information regarding the cost of the goods or services in question.

In another aspect, a customer entity may report a crime, in progress or not, or emergency via text message. The customer entity may text the local police, fire department or other authorities about such crime or other emergency.

In an aspect, a customer entity may send a text message to an insurance agent or other provider entity regarding the cost and other information about insurance policies and other services offered by the provider entity. The provider entity may then reply with pertinent information regarding the inquiry (i.e., pricing, coverage, policy, plans and any other information the provider entity wishes to provide the customer entity) among other information.

In yet another aspect of the present disclosure, a customer entity may communicate with a real estate agent or user entity regarding property for rent, lease or sale via text message communication. The number posted for inquiry may go directly to a text message application where the user entity may further converse with the customer entity. The customer may inquire as to availability, location, amenities or price of a property among other information. The real estate agent may then give information about the property or properties and/or schedule an appointment to see the property or properties.

In another aspect of the present disclosure, a customer entity may be located via text messaging. A user entity may use this information to track customer entities in a variety of circumstances and to interact with various databases of goods and services to be presented to the customer entity among other uses.

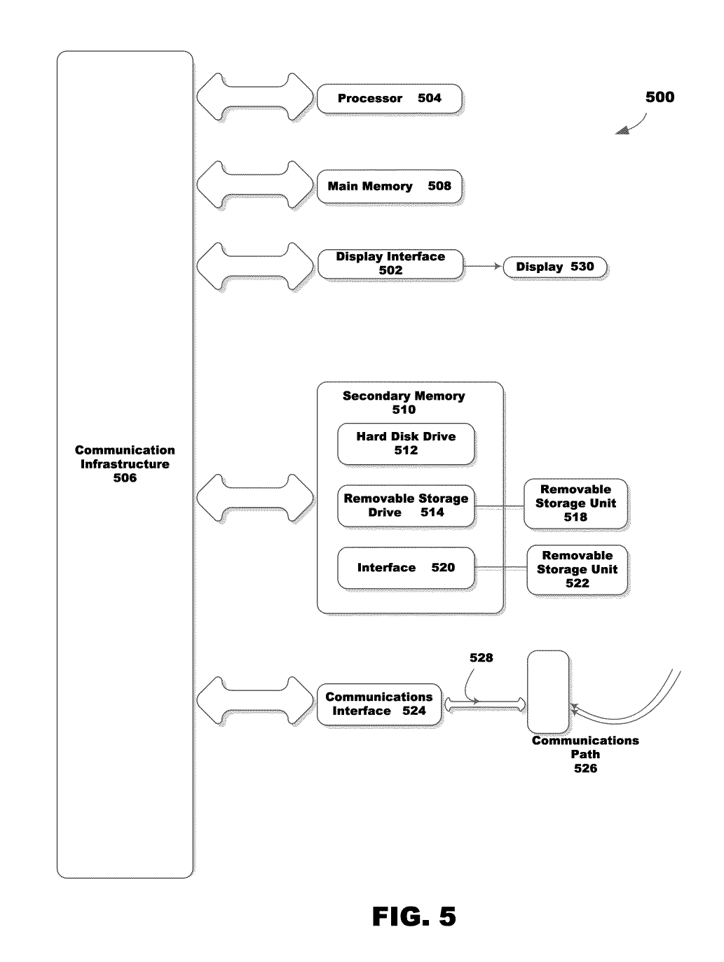

In one aspect, system 100 may be directed toward one or more computer systems capable of carrying out the functionality (e.g., process 200) described herein. An example of a computer system 500 is shown in FIG. 5. Computer system 500 includes one or more processors, such as processor 504. Processor 504 may be connected to a communication infrastructure 506, such as a communications bus or network, for example. Various software aspects are described in terms of this exemplary computer system. After reading this description, it will become apparent to a person skilled in the relevant art(s) how to implement the disclosure using other computer systems and/or architectures.

Computer system 500 can include a display interface 502 that forwards graphics, text and other data from communication infrastructure 506, or from a frame buffer (not shown), for display via display unit 530. Computer system 500 may also include a main memory 508, preferably a random access memory (RAM), and may further include a secondary memory 510. Secondary memory 510 may include, for example, a hard disk drive 512 and/or a removable storage drive 514, representing a floppy disk drive, a magnetic tape drive, or an optical disk drive, for example. Removable storage drive 514 reads from and/or writes to a removable storage unit 518 in a manner well known in the relevant art. Removable storage unit 518 represents a floppy disk, magnetic tape, or an optical disk, which is read by and written to by removable storage drive 514. As can be appreciated, removable storage unit 518 includes a computer usable storage medium having stored therein computer software and/or data.

In alternative aspects, secondary memory 510 may include other similar devices for allowing computer programs or other instructions to be loaded into computer system 500. Such devices may include, for example, a removable storage unit 522 and an interface 520. Examples of such may include a program cartridge and cartridge interface, such as may be found in video game devices, a removable memory chip, such as an erasable programmable read only memory (EPROM), or programmable read only memory (PROM), and associated socket and other removable storage units 522 and interfaces 520, which allow software and data to be transferred from the removable storage unit 522 to computer system 500.

Computer system 500 may also include a communications interface 524. Communications interface 524 allows software and data to be transferred between computer system 500 and external devices. Examples of a communications interface 524 may include a modem, a network interface such as an Ethernet card, a communications port, and a Personal Computer Memory Card International Association (PCMCIA) slot and card. Software and data transferred via communications interface 524 are in the form of non-transitory signals 528 which may be electronic, electromagnetic, optical or other signals capable of being received by communications interface 524. Signals 528 may be provided to communications interface 524 via a communications path or channel 526. Channel 526 may carry signals 528 and may be implemented using wire or cable, fiber optics, a telephone line, a cellular link, a radio frequency (RF) link, and other communications channels.

In this document, the terms “computer program medium” and “computer usable medium” are used to generally refer to media such as removable storage drive 514, a hard disk installed in hard disk drive 512, and signals 528. These computer program products provide software to computer system 500, wherein the present disclosure is directed to such computer program products.

Computer programs (also referred to as computer control logic), may be stored in main memory 508 and/or secondary memory 510. Computer programs may also be received via communications interface 524. Such computer programs, when executed, enable computer system 500 to perform the features of the present disclosure, as discussed herein. In particular, the computer programs, when executed, enable processor 504 to perform the features of the present disclosure. Accordingly, such computer programs represent controllers of the computer system 500.

In an aspect where the disclosure is implemented using software, the software may be stored in a computer program product and loaded into computer system 500 using removable storage drive 514, hard drive 512 or communications interface 524. The control logic (software), when executed by processor 504, causes processor 504 to perform the functions of the disclosure as described herein.

In another aspect, the disclosure is implemented primarily in hardware using, for example, hardware components such as application specific integrated circuits (ASICs). Implementation of the hardware state machine so as to perform the functions described herein will be apparent to persons skilled in the relevant art(s).

As will be apparent to one skilled in the relevant art(s) after reading the description herein, the computer architecture shown in FIG. 5 may be configured as a desktop, a laptop, a server, a tablet computer, a PDA, a mobile computer, an intelligent communications device or the like. In yet another aspect, the disclosure may be implemented using a combination of both hardware and software.

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A system for facilitating the communication of messages with specified information to one or more users via wireless device messaging, comprising:
a web server configured to provide a graphical user interface (GUI), via at least a first network, to a plurality of computing devices; wherein said GUI is configured to facilitate the creation of messages by each of said plurality of users;
at least one gateway, coupled to said web server, configured to send, via at least a second network, messages created by each of said plurality of users to a plurality of endpoints; and
a private branch exchange server, coupled to said at least one gateway, configured to route reply messages from each of said plurality of endpoints to the originating one of said plurality of users;
whereby said system allows said users to engage in a high volume of and user-specific two-way communications with said plurality of endpoints.

2. The system of claim 1, wherein said first network is the global, public Internet.

3. The system of claim 1, wherein said second network is one of: a CDMA network; a TDMA network; a radio network; and a GSM network.

4. The system of claim 1, wherein said reply messages originate from at least one of: a desktop computer; a laptop computer; a personal digital assistant; a tablet; and a mobile computer.

5. The system of claim 1, wherein said GUI comprises: an elevator user interface configured to allow each of said plurality of users to manage a plurality of dialogues with at least a subgroup of said plurality of endpoints.

6. The system of claim 1, wherein each of said endpoints is one of: a customer; a client; a patient; a patron; a donor; a constituent; a service provider; and a goods provider; for an organization.

7. The system of claim 1, wherein each of the messages is one of: an SMS message; mobile telephone text messaging; a voicemail message; a pager message; an instant message; and an email message.
